(19) United States
(12) Patent Application Publication
(10) Pub. No.: US 2003/0120722 A1
(43) Pub. Date: Jun. 26, 2003

(54) Persistent process software architecture

(76) Inventors: Damien R. Forkner, Corvallis, OR (US); Jeffrey M. Munsey, Ne Albany, OR (US)

Correspondence Address: HEWLETT-PACKARD COMPANY, Intellectual Property Administration, P.O. Box 272400, Fort Collins, CO, 80527-2400, US

(21) Appl. No.: 10/029,774

(22) Filed: Dec. 20, 2001

(51) Int. Cl. G06F 15/16

(52) U.S. Cl. 709/203; 709/229; 709/311

(57) ABSTRACT

An application runs on a server. The application includes a persistent process and a plurality of transient processes. The persistent process generates dynamic and interactive content for the application. Each transient process from the plurality of transient processes is launched to handle a client request from a client. The transient process parses the client request, forwards the client request to the persistent process, captures a result from the persistent process and forwards the result to the client.

### BACKGROUND OF THE INVENTION

The present invention pertains to obtaining information through a network and pertains particularly to a persistent process software architecture.

The Internet started as a cooperative research effort of the United States Federal Government known as the Advanced Research Project Agency Network (ARPAnet). The ARPAnet tied universities and research and development organizations to the U.S. military establishment. More recently, the Internet has extended its use commercially and internationally. It is the world's largest computer network.

A Uniform Resource Locator (URL) address is an Internet address. A URL address consists of a string expression that designates a resource (referred to herein as a URL page) on the Internet. For example the resource is a particular file on a computer connected to the Internet.

Web browsers such as Netscape Navigator browser available from Netscape, and Internet Explorer browser available from Microsoft Corporation use URL addresses to access resources (URL pages) on the Internet. The World Wide Web (Web) allows users to navigate Internet resources intuitively, without using internet protocol (IP) addresses or other special technical knowledge. The Web is made up of interconnected web pages, or web documents stored on web servers. These pages are accessed with the use of a web browser.

The Web uses a transfer method known as Hypertext Transfer Protocol (HTTP). One format for information transfer is to create documents using Hypertext Markup Language (HTML). HTML pages are made up of standard text as well as formatting codes that indicate how the page should be displayed. A web browser reads these codes in order to display the page.

Each Web page may contain graphics, video and audio information in addition to text. Hidden behind certain text, pictures or sounds are connections, known as hypertext links (links), to other pages within the same web server or on other computers within the Internet. Each link is directed to a web page by a Uniform Resource Locator (URL). A user may also specify a known URL by writing it directly into the command line of a web browser.

The Web is a request-based environment. A user makes a request in the form of an HTTP request that is routed to the appropriate web server, which responds with the appropriate HTML content.

The standard method for generating dynamic content is to use the Common Gateway Interface (CGI). In this model, a user request for dynamic content arrives at a web server and is handled by execution of a specific program on the web server, usually in a protected memory space. The program then terminates after the dynamic content is generated. Once the program terminates, it cannot be accessed again. This can be disadvantageous for a large process that loads many libraries and/or includes high overhead associated with setup and teardown of the large process. This method of terminating programs also results in the lack of a good way to maintain state for a client session, poor scalability, synchronization problems, and extreme difficulty creating logical program flow.

A common method of overcoming some of these limitations is to use a web-server add-on for faster CGI, such as Apache Modules written with the Perl language (ModPerl). Such web-server add-ons keep processes alive to avoid setup and teardown overhead. However, such web-server add-ons cannot help a program maintain state, solve synchronization problems, or create logical program flow.

Another method of overcoming some of the limitations of typical CGI implementations is to use the Internet Information Server known as Internet Server Application Program Interface (ISAPI) developed by Microsoft Corporation. ISAPI runs CGI programs in the memory space of the web server, resulting in faster execution. Again, this solution does not help a program maintain state, solve synchronization problems, or create logical program flow.

The problem with all of these solutions and similar ones is that they do not help create an environment capable of supporting large-scale interactive web applications.

### SUMMARY OF THE INVENTION

In accordance with the preferred embodiment of the present invention, an application runs on a server. The application includes a persistent process and a plurality of transient processes. The persistent process generates dynamic and interactive content for the application. Each transient process from the plurality of transient processes is launched to handle a client request from a client. The transient process parses the client request, forwards the client request to the persistent process, captures a result from the persistent process and forwards the result to the client.

### BRIEF DESCRIPTION OF THE DRAWINGS

FIG. 1 is a simplified block diagram illustrating operation of multiple transient processes with a single persistent process within a server in accordance with a preferred embodiment of the present invention.

FIG. 2 is a simplified flow chart that illustrates operation of a transient process within a server in accordance with a preferred embodiment of the present invention.

FIG. 3 is a simplified flow chart that illustrates operation of a persistent process within a server in accordance with a preferred embodiment of the present invention.

### DETAILED DESCRIPTION OF THE PREFERRED EMBODIMENT

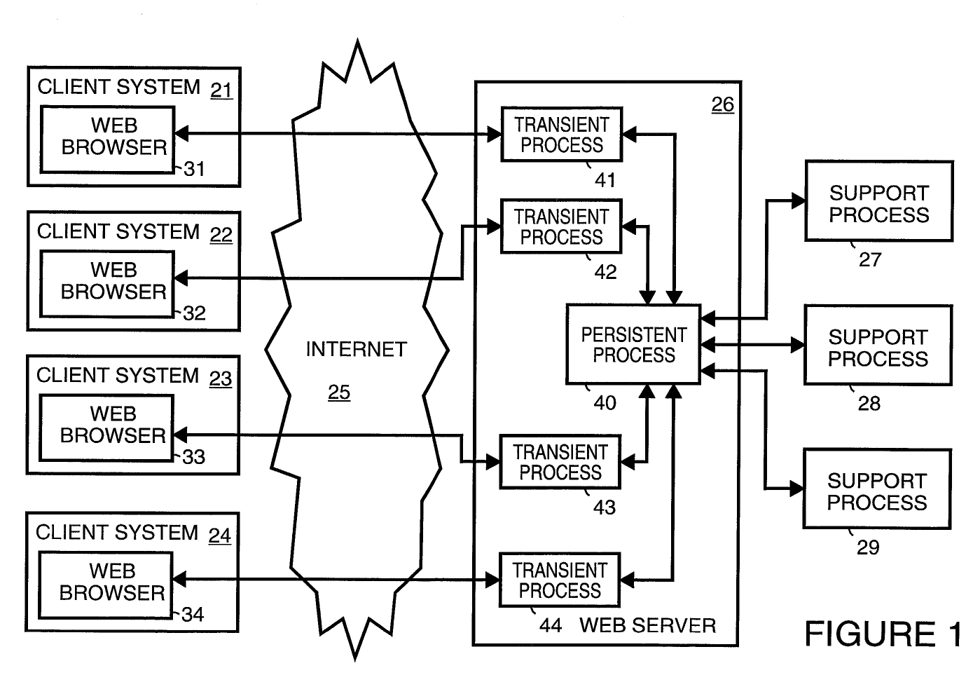

FIG. 1 is a simplified block diagram showing a web server 26 interacting through the internet 25 with a web browser 31 within a client system 21, a web browser 32 within a client system 22, a web browser 33 within a client system 23 and a web browser 34 within a client system 24.

Within a web server 26, a separate small transient CGI process is launched to interact with each web browser within a client system. For example, FIG. 1 shows a transient process 41 launched to interact with web browser 31 within client system 21, a transient process 42 launched to interact with web browser 32 within client system 22, a transient process 43 launched to interact with web browser 33 within client system 23, and a transient process 44 launched to interact with web browser 34 within client system 24. Each of transient process 41, transient process 42, transient process 43 and transient process 44 interact with persistent process 21.

Each of transient processes 41, 42, 43 and 44 interact with a persistent process 40 in order to generate highly dynamic and interactive content required for a fully-functioning web application. The persistent process is used, for example, to perform complicated and memory-intensive processing to generate results. The complicated and memory-intensive processing can include, for example, generating HTML involving data from other connected databases and systems. Generating the HTML may include, for example, complex filtering, sorting, and searching performed in real-time or looked up from memory caches to provide HTML content that is rich in data and customized for the user requesting the page. The persistent process may thus be useful to manipulate large amounts of data quickly and efficiently for incoming requests by building large memory caches that do not need to be destroyed because the process does not need to shut down.

For example, persistent process 40 can pre-cache dynamic content for a richly interactive user experience. The overhead of set-up and tear-down of a large CGI process is avoided, and each user can view highly dynamic content in an application-like setting over the web. The resulting speed scalability, and possibilities for very complex user interaction can be used to automate very complicated web applications. Persistent process 40 can make use of support processes available outside web server 26. For example, FIG. 1 shows persistent process 40 communicating with a support process 27, a support process 28 and a support process 29. While FIG. 1 shows only persistent process 40, a network of persistent processes can simultaneously exist within web server 26. Each persistent process generates highly dynamic and interactive content required for a fully-functioning web application.

Using transient processes linked to a persistent process 40 solves many of the problems inherent to creating complex web applications. First, the speed limitations of CGI are overcome by using a very small executive transient process whose job is to parse a client request, send it on to a persistent process, capture the result, and transmit it back to the client's web browser. This executive transient process generally does not load files or libraries from disk, manage the client's state, or do any complicated processing. Thus a transient process handles simple requests for file retrieval without forwarding the requests to persistent process 40. The transient process forwards requests that require more complex processing, such as requests that require generating HTML results, on to persistent process 40.

The complex synchronization problems of managing multiple possibly concurrent client connections is managed by persistent process 40. The client requests coming from the transient process are naturally ordered in a queue and processed one at a time.

The complexity of maintaining client state is handled by the persistent process 40. State is maintained in a memory data structure instead of passed back and forth to the client in the form of hidden variables or a cookie. This is a much simpler way to handle the complex logical flow of a complicated application.

The system shown in FIG. 1 is inherently much more scalable than a standard CGI solution. Complicated processing can be offloaded from web server 26 and given to other processes, such as support process 27, support process 28 and support process 29, running on other servers. The use of lightweight transient process means that each web server can handle many more simultaneous requests.

The system shown in FIG. 1 allows for an efficient operating speed, caching, code simplicity, and the ability to build a complex, richly interactive application on the World Wide Web. By its nature, dynamic content cannot be easily cached. Using the web server architecture illustrated by FIG. 1, persistent process 40 can cache ahead dynamic content and serve up very, very fast results. Costly disk reads can be almost entirely eliminated. Under this architecture, code can be nicely abstracted to handle generic cases and need not be replicated to multiple CGI-executed programs. In fact, only one executing CGI program is necessary. All of the code complexity can be contained in persistent process 40. The embodiment of the present invention shown in FIG. 1 allows the creation of complex, richly interactive World Wide Web applications that would otherwise be very, very difficult to implement using CGI.

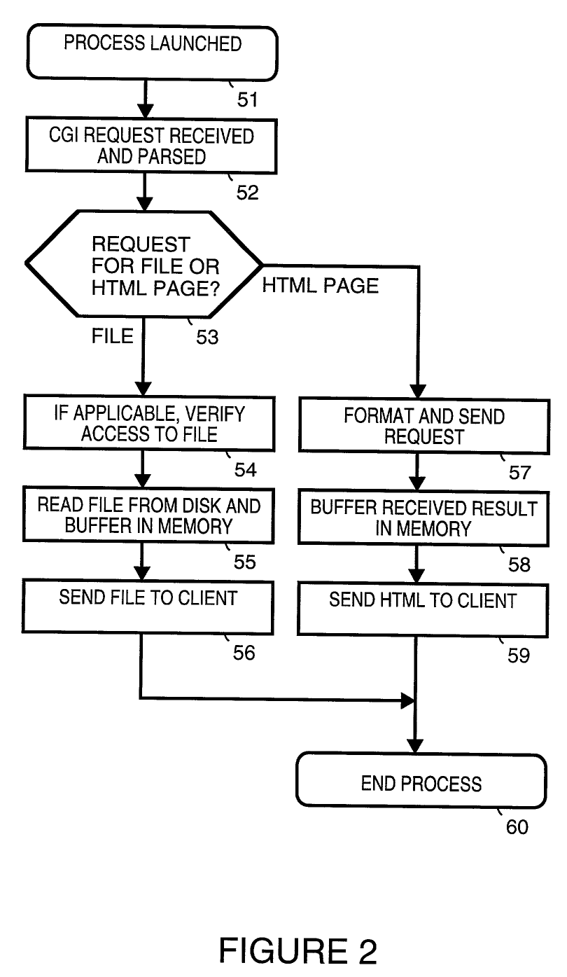

FIG. 2 is a simplified flow chart that illustrates operation of each transient processes 41, 42, 43 and 44 within web server 26. In a step 51, the transient process is launched by web server 26 when a client request is received. The client request is a Common Gateway Interface (CGI) request. In step 52, the CGI request is received and parsed.

In a step 53, the transient process determines whether the request is for a file or for an HTML page. If it is for a file, in a step 54, the transient process verifies with persistent process 40 that there is access to the file. Step 54 is done only if it is applicable to verify file access.

In a step 55, the transient process reads the file from disk storage within web server 26 and buffers the file in memory. In a step 56, the file is sent to the client that requested the file.

If in step 53 the transient process determines that the request is for an HTML page, in a step 57, the transient process formats a request and sends the formatted request to persistent process 40. For example, the transient process communicates with persistent process 40 using Transmission Control Protocol (TCP) sockets, datagrams pipes or some other type of Interprocess Communication (IPC) method.

Once persistent process 40 responds to the request, in a step 58, the transient process buffers the result in memory. In a step 59, the transient process sends the HTML page to the client who requested the HTML. After responding to the client with the information requested by the client, in a step 60, the transient process ends. The use of transient processes to buffer client requests and responses allows persistent process 40 to be tied up for only a minimum amount of time. Since the transient processes only pass complete, well-formatted requests onto persistent process 40, this isolates persistent process 40 from any inconsistencies within HTTP. This provides a significant amount of protection for persistent process 40 because CGI processes can die at any time.

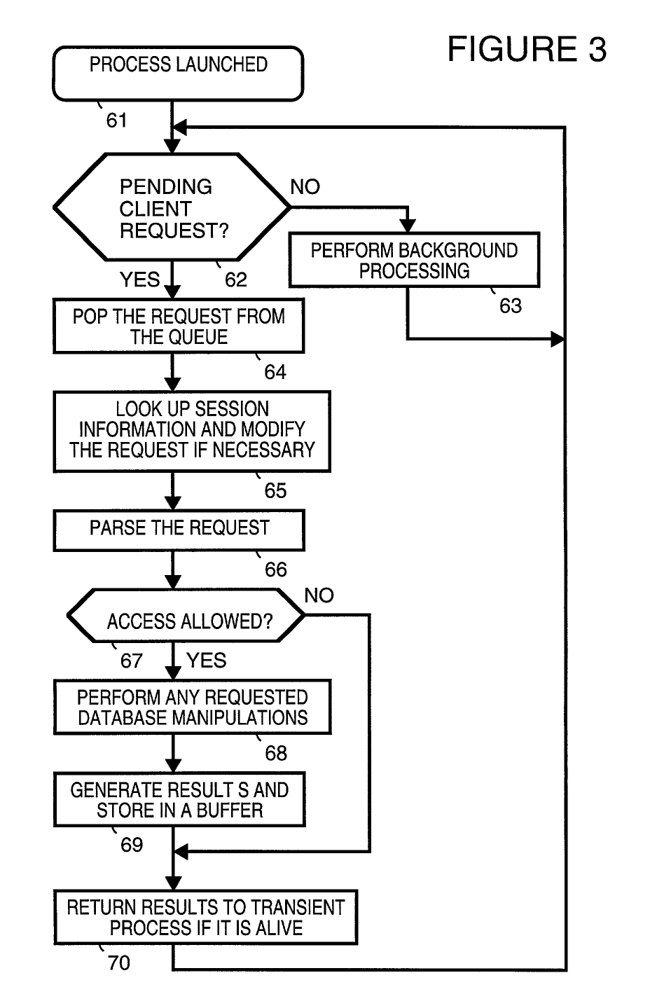

FIG. 3 is a simplified flow chart that illustrates operation of persistent process 40. In a step 61, persistent process 40 is typically launched once, for example, at the startup of server 26 or when needed.

In a step 62, a check is made to see if there is a pending client request forwarded to persistent process 40 by a transient process. If not, in a step 63 persistent process 40 performs background processing. For example, the background processing is a discreet amount of background processing, such as look-ahead pre-caching. After performing the background processing, persistent process 40 returns to step 62 where a check is made to see if there is a pending client request forwarded to persistent process 40 by a transient process.

If a pending client request is forwarded to persistent process 40, in a step 64, the request is popped from the queue. As discussed above, the client requests coming from the transient process are naturally ordered in a queue and processed one at a time.

In a step 65, persistent process 40 looks up session information (e.g., state, synchronization and logic program flow) and modifies the request if necessary to take into account the session information. The existence of this step allows persistent process 40 to maintain state for a client session, perform synchronization and create logical program flow. In a step 66, persistent process 40 parses the request. Parsing is performed by persistent process 40 to accurately analyze the request and ascertain exactly what is being requested.

In a step 67, a security check is made to see if access is allowed. If access is not allowed the results is set to “access denied” and a jump is made to a step 70. If access is allowed, a step 68 is performed.

In step 68, persistent process 40 performs any requested database manipulations. This may include, for example, complex filtering, sorting, and searching. Such actions can be performed in real-time or looked up from memory caches to provide HTML content that is rich in data and customized for the user requesting the page. When persistent process 40 is required to manipulate large amounts of data quickly and efficiently, persistent process 40 can build large memory caches that never need to be destroyed because persistent process 40 typically does not need to shut down. This allows persistent process 40 to manipulate large amounts of data quickly and efficiently for incoming requests.

In a step 69, persistent process 40 generates results (e.g., an HTML page) and stores the results in a buffer. When generating the results, persistent process 40 uses as much caching as possible. As discussed above, this allows persistent process 40 to manipulate large amounts of data quickly and efficiently for incoming requests.

In step 70, persistent process 40 sends the results back to the transient process. This step is performed provided the transient process is still alive. If after checking, persistent process 40 determines the transient process is still alive, persistent process can forward the results directly to the requester, create a new transient process to be used to forward the results to the requester, or performs some other action or actions as is predetermined by programming instructions within persistent process 40. After performing step 70, persistent process 40 returns to step 62 where a check is made to see if there is another pending client request forwarded to persistent process 40 by a transient process.

In the preferred embodiment of the present invention, requests from users via transient processes are queued and processed one at a time in the order they are received, eliminating synchronization problems. Since persistent process 40 remains alive even when they are no requests pending, persistent process 40 is able to do a lot of caching in memory, leading to very fast creation of very complex dynamic content. For example, persistent process 40 performs look-ahead caching during background processing. In the preferred embodiment, persistent process handles all client state information and thus handles the complex logical flow of web applications. The transient process handle state for each user and pre-cache dynamic pages to minimize the processing time required to produce each page. Processing can be split up among multiple machines or file servers.

The foregoing discussion discloses and describes merely exemplary methods and embodiments of the present invention. As will be understood by those familiar with the art, the invention may be embodied in other specific forms without departing from the spirit or essential characteristics thereof. For example, while the disclosed preferred embodiment of the present invention utilized web applications operating on a web server, as will be readily understood by persons of ordinary skill in the art, the present invention is equally applicable to any server which interacts with different users, for example, through a network. Accordingly, the disclosure of the present invention is intended to be illustrative, but not limiting, of the scope of the invention, which is set forth in the following claims.

What is claimed is:

1. A server comprising:
an application, the application comprising:
a persistent process that generates dynamic and interactive content for the application; and,
a plurality of transient processes, wherein each transient process is launched to handle a client request from a client by parsing the client request, forwarding the client request to the persistent process, capturing a result from the persistent process and forwarding the result to the client.

2. A server as in claim 1 wherein the persistent process utilizes a support process outside the server.

3. A server as in claim 1 wherein the transient processes implement a Common Gateway Interface (CGI).

4. A server as in claim 1 wherein the persistent process includes a request queue.

5. A server as in claim 1 wherein the persistent process performs background processing when there are no pending client requests.

6. A server as in claim 1 wherein each of the plurality of transient processes terminates after forwarding the result to the client.

7. A server as in claim 1 wherein when a first client sends a file request for a file, a first transient process obtains and forwards the file to the first client.

8. A server as in claim 1 wherein when a first client sends a file request for a file, a first transient process, after verifying access to the file, obtains and forwards the file to the first client.

9. A server as in claim 1 wherein when the plurality of transient processes communicate with the persistent process via Interprocess Communication (IPC).

10. A server as in claim 1 wherein the persistent process performs background processing when there are no pending client requests, the background processing including look-ahead caching.

11. A server as in claim 1 wherein the persistent process uses a queue to process client requests forwarded by the plurality of transient processes to the persistent process.

12. A method performed within a server, the method comprising the following steps:
(a) running a persistent process that generates dynamic and interactive content for an application; and,
(b) for each of a plurality of client requests, performing the following substeps:
(b.1) launching a transient process to handle each client request,
(b.2) parsing each client request by the transient process,
(b.3) forwarding the client request to the persistent process,
(b.4) capturing a result from the persistent process, and
(b.5) forwarding the result to a client.

13. A method as in claim 12 wherein step (a) includes the following substep:
(a.1) utilizing, by the persistent process, a support process outside the server.

14. A method as in claim 12 wherein the transient processes implement a Common Gateway Interface (CGI).

15. A method as in claim 12 wherein step (a) includes the following substep:
(a.1) performing, by the persistent process, background processing when there are no pending client requests.

16. A method as in claim 12 wherein step (b) additionally includes the following substep:
(b.6) terminating the transient process after forwarding the result to the client.

17. A method as in claim 12 additionally comprising the following step:
(c) when a first client sends a file request for a file, performing the following substeps:
(c.1) obtaining, by a first transient process, the file, and
(c.2) forwarding, by the first transient process, the file to the first client.

18. A method as in claim 12 additionally comprising the following step:
(c) when a first client sends a file request for a file, performing the following substeps:
(c.1) verifying a right of the first client to access the file,
(c.2) obtaining, by a first transient process, the file, and
(c.3) forwarding, by the first transient process, the file to the first client.

19. A method as in claim 12 wherein step (a) includes the following substep:
(a.1) performing, by the persistent process, background processing when there are no pending client requests, the background processing including look-ahead caching.

20. A method as in claim 12 wherein step (a) includes the following substep:
(a.1) using a queue to process client requests forwarded by the plurality of transient processes to the persistent process.

21. Storage media for storing an application, the application comprising:
a persistent process that generates dynamic and interactive content for the application; and,
a plurality of transient processes, wherein each transient process is launched to handle a client request from a client by parsing the client request, forwarding the client request to the persistent process, capturing a result from the persistent process and forwarding the result to the client.

22. Storage media as in claim 21 wherein the persistent process performs background processing when there are no pending client requests.

23. Storage media as in claim 21 wherein each of the plurality of transient processes terminates after forwarding the result to the client.

24. Storage media as in claim 21 wherein when a first client sends a file request for a file, a first transient process obtains and forwards the file to the first client.

25. Storage media as in claim 21 wherein the persistent process performs background processing when there are no pending client requests, the background processing including look-ahead caching.

26. Storage media as in claim 21 wherein the persistent process uses a queue to process client requests forwarded by the plurality of transient processes to the persistent process.
